(19) United States
(12) Patent Application Publication
(10) Pub. No.: US 2008/0119372 A1
(43) Pub. Date: May 22, 2008

(54) Microarray and Method of Fabricating the Same

(76) Inventors: Jung-hwan Hah, Hwaseong-si (KR); Sung-min Chi, Hwaseong-si (KR); Kyoung-seon Kim, Suwon-si (KR); Won-sun Kim, Suwon-si (KR)

Correspondence Address: Frank Chau, Esq.;F. CHAU & ASSOCIATES, LLC, 130 Woodbury Road, Woodbury, NY, 11797, US

(21) Appl. No.: 11/748,163

(22) Filed: May 14, 2007

(30) Foreign Application Priority Data
Jul. 17, 2006 (KR) 10-2006-0066634

(51) Int. Cl. C40B 40/14; C40B 50/00

(52) U.S. Cl. 506/20; 506/23

(57) ABSTRACT

A microarray includes a substrate, a siloxane resin layer represented by the following general formula 1 or 2 and includes a siloxane resin having a molecular weight of about 1,000 to about 10,000:

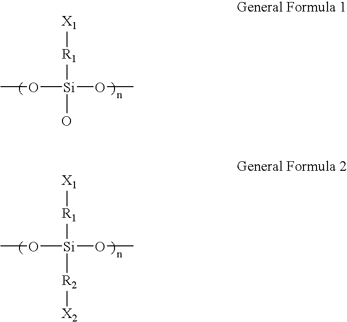

where R₁ and R₂ are independently hydrocarbons having 1 to 30 carbon atoms and X₁ and X₂ are independently a hydroxyl, aldehyde, carboxyl amino, amide, thiol halo, or sulfonate group, and a plurality of oligomer probes coupled with the siloxane resin layer.

### CROSS-REFERENCE TO RELATED APPLICATION

This application claims priority from Korean Patent Application No. 10-2006-0066634 filed on Jul. 17, 2006, the disclosure of which is hereby incorporated by reference herein in its entirety.

### BACKGROUND OF THE INVENTION

1. Technical Field

The present disclosure relates to a microarray and to a method of fabricating the same, and more particularly, to a microarray having an oligomer probe coupled thereto and to a method of fabricating the same.

2. Description of the Related Art

With the advancements made in genome projects, the genomic nucleotide sequences of various organisms have been disclosed. Thus, there has been an increasing interest in biopolymer microchips, and in particular, microarrays. Microarrays are tools that have been widely used in, for example, gene expression profiling, genotyping through detection of mutation or polymorphism such as Single-Nucleotide Polymorphism (SNP), a protein or peptide assay, potential drug screening, development and preparation of novel drugs, etc.

To enable such assay or detection, a microarray may include a plurality of oligomer probes provided on a substrate. The plurality of oligomer probes have different sequences on different regions and are immobilized on the substrate. A widely available glass substrate or a silicon substrate has few or no functional groups used for coupling, with the oligomer probes. Thus, it may be necessary to provide the substrate with an active layer serving to mediate coupling with the oligomer probes to ensure more stabilized, densely packed immobilization of the oligomer probes.

Research into a silicon oxide or silicon, nitride layer to be employed as such an active layer is currently under way. With the above-mentioned research methods, the silicon oxide or silicon nitride layer is laminated on the substrate through oxidation or chemical vapor deposition. However, the laminating process of the silicon oxide or silicon nitride layer, which is carried out at a high temperature for a prolonged time, may deteriorate the processing efficiency. In addition, in a case where a target sample is subjected to complementary hybridization with oligomer probes, necessitating a free interaction between the target sample and oligomer probes, the silicon oxide or silicon nitride layer having surface functional groups relatively short in length may disturb the free interaction between the target sample and oligomer probes.

### SUMMARY OF THE INVENTION

Exemplary embodiments of the present invention provide a microarray which serves to mediate coupling with oligomer probes on a substrate and provides a spatial margin for a free interaction between the oligomer probes and a target sample.

The exemplary embodiments of the present invention also provide a method of preparing a microarray on a substrate.

In accordance with an exemplary embodiment of the present invention, a microarray is provided. The microarray includes a substrate, a siloxane resin layer represented by the following general formula 1 or 2 and which includes a siloxane resin having a molecular weight of about 1,000 to about 10,000:

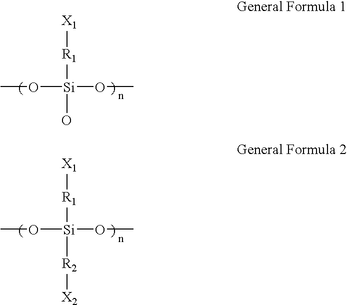

wherein R₁ and R₂ are independently hydrocarbons having 1 to 30 carbon atoms and X₁ and X₂ are independently a hydroxyl, aldehyde, carboxyl, amino, amide, thiol, halo, or sulfonate group, and a plurality of oligomer probes coupled with the siloxane resin layer.

In accordance with an exemplary embodiment of the present invention, a method of fabricating a microarray is provided. The method includes providing a substrate, forming a siloxane resin layer represented by the following general formula 1 or 2 and which includes a siloxane resin having a molecular weight of about 1,000 to about 10,000:

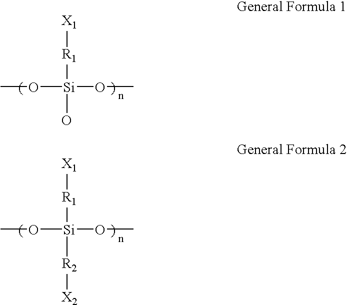

wherein R₁ and R₂ are independently hydrocarbons having 1 to 30 carbon atoms and X₁ and X₂ are independently a hydroxyl, aldehyde, carboxyl, amino, amide, thiol, halo, or sulfonate group, and coupling oligomer probes with the siloxane resin layer.

### BRIEF DESCRIPTION OF THE DRAWINGS

Exemplary embodiments of the present invention can be understood in further detail from the following detailed description taken in conjunction with the attached drawings, in which:

FIG. 1 is a sectional view illustrating a microarray according to an exemplary embodiment of the present invention;

FIG. 2 is a sectional view illustrating a microarray according to an exemplary embodiment of the present invention;

FIG. 3 is a sectional view illustrating a microarray according to an exemplary embodiment of the present invention;

FIG. 4 is a sectional view illustrating a microarray according to an exemplary embodiment of the present invention;

FIG. 5 is a sectional view illustrating a microarray according to an exemplary embodiment of the present invention;

FIG. 6 is a sectional view illustrating a microarray according to an exemplary embodiment of the present invention;

FIGS. 7 through 12 are sectional views of intermediate structures for illustrating a method of manufacturing the microarray shown in FIG. 1;

FIGS. 13 and 14 are sectional views of intermediate structures for illustrating a method of manufacturing the microarray shown in FIG. 2;

FIG. 15 is a sectional view of the intermediate structure for illustrating a method of manufacturing the microarray shown in FIG. 3;

FIG. 16 is a sectional view of the intermediate structure for illustrating a method of manufacturing the microarray shown in FIG. 4:

FIGS. 17 and 18 are sectional views of intermediate structures for illustrating a method of manufacturing the microarray shown in FIG. 5; and

FIG. 19 is a sectional view of the intermediate structure for illustrating a method of manufacturing the microarray shown in FIG. 6.

### DETAILED DESCRIPTION OF THE INVENTION

The present invention may, however, be embodied in many different forms and should not be construed as being limited to the exemplary embodiments set forth herein.

Thus, in some embodiments, well-known processing steps are generally not described in detail to avoid unnecessarily obscuring the description of the present invention.

It is noted that the use of any and all examples, or exemplary terms provided herein is intended merely to better illuminate the invention and is not a limitation on the scope of the invention unless otherwise specified. The use of the terms “a” and “an” and “the” and similar referents in the context of describing the invention (especially in the context of the following claims) are to be construed to cover both the singular and the plural, unless otherwise indicated herein or clearly contradicted by context. The terms “comprising” and “comprises” are to be construed as open-ended terms (i.e., meaning “including, but not limited to,”) to indicate any and all possible combinations of one or more of the associated components, steps, operations, and/or devices unless otherwise noted. It will also be understood that the term “and/or” as used herein refers to and encompasses any and all possible combinations of one or more of the associated listed items. In the drawings, like reference numerals denote like members.

In addition, the present invention will be described with reference to perspective views, cross-sectional views, and/or plan views, in which preferred embodiments of the invention are shown. Thus, the profile of an exemplary view may be modified according to manufacturing techniques and/or allowances. That is, the embodiments of the invention are not intended to limit the scope of the present invention but cover all changes and modifications that can be caused due to a change in manufacturing process. Thus, regions shown in the drawings are illustrated in schematic form and the shapes of the regions are presented simply by way of illustration and not as a limitation. In the drawings, the thickness of layers aid regions are exaggerated or reduced for clarity.

A method of manufacturing a microarray according to exemplary embodiments of the present invention will now be described more fully with reference to the accompanying drawings, in which exemplary embodiments of the invention are shown.

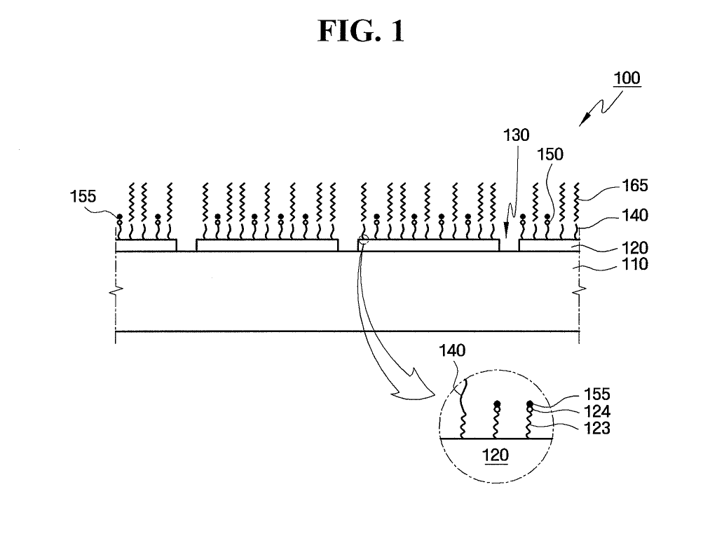

A microarray according to an embodiment of the present invention will first be described. FIG. 1 is a sectional view illustrating a microarray (100) according to an embodiment of the present invention.

Referring to FIG. 1, the microarray 100 includes a substrate 110; a plurality of probe cell actives 120 disposed on the substrate 110 in the form of a siloxane resin layer; a plurality of oligomer probes 165 coupled onto the probe cell actives 120; and a probe cell isolation region 130 which isolates the probe cell actives 120 and does not couple with the oligomer probes 165.

As used herein, fire term “oligomer” is a low-molecular weight polymer molecule consisting of two or more covalently bound monomers. Oligomers have a molecular weight of about 1,000 or less but the present invention is not limited thereto. The oligomer may include about 2-500 monomers, preferably about 5-30 monomers. The monomers may be nucleosides, nucleotides, amino acids, peptides, etc. according to the type of probes. In the present invention, previously synthesized oligomer probes may be coupled to active regions, or oligomer probes may be synthesized on active regions by in-situ photolithography.

As used herein, the terms “nucleosides” and “nucleotides” include not only known purine and pyrimidine bases, but also, for example, methylated purines or pyrimidines, acylated purines or pyrimidines, etc. Furthermore, the “nucleosides” and “nucleotides” include not only known (deoxy)ribose, but also, for example, a modified sugar which contains a substitution of a halogen atom or an aliphatic group for at least one hydroxyl group or is functionalized with ether, amine, or the like.

As used herein, the term “amino acids” are intended to refer to not only naturally occurring. L-, D-, and nonchiral amino acids, but also, for example, to modified amino acids, amino acid analogs, etc.

As used herein, the term “peptides” refer to compounds produced by an amide bond between the carboxyl group of one amino acid and the amino group of another amino acid.

Accordingly, the oligomer probes 165 may be composed of, for example, two or more nucleosides, nucleotides, amino acids, peptides, or the like.

The substrate 110 may be a flexible or rigid substrate. Examples of a flexible substrate include a nylon membrane, a nitrocellulose membrane, a plastic film, etc. When a rigid substrate is used as the substrate 100, the substrate 100 may be, for example, a silicone substrate, a transparent glass (e.g., soda-lime glass) substrate, etc. The use of a silicone substrate or a transparent glass substrate as the substrate 100 is beneficial in that non-specific binding hardly occurs during hybridization. Furthermore, a transparent glass substrate is transparent to visible light and/or UV light, and thus, is beneficial in detection of a fluorescent material. In addition, when a silicone substrate or a transparent glass substrate is used as the substrate 100, it is possible to employ various thin film formation processes and photolithography processes that have been well established and stably applied in the fabrication of semiconductor devices or liquid crystal display (LCD) panels.

The plurality of probe cell actives 120 formed as a siloxane resin layer are disposed on the substrate 110. The siloxane resin layer is represented by the following general formula 1 or 2 and includes a siloxane resin having a molecular weight of about 1,000 to about 10,000:

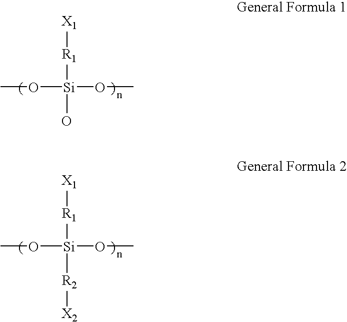

where R₁ and R₂ are independently hydrocarbons having 1 to 30 carbon atoms, for example, straight chain or branched alkyl, alkenyl or alkynyl group; cycloalkyl or cycloalkenyl group. In addition, in general formulas 1 and 2, at least some groups are exposed on the surfaces of the probe cell actives 120 to become immobilizing branches 123. In a case where the oligomer probes 165 are directly coupled with the immobilizing branches 123, to provide a spatial margin for ensuring a free interaction, e.g., hybridization, between the oligomer probes 165 and the immobilizing branches 123, R₁ and R₂ are preferably hydrocarbons having at least 5 carbon atoms. Meanwhile, in view of the structural stability of the immobilizing branches 123, the numbers of carbon atoms in R₁ and R₂ are preferably not greater than 15.

in addition, in general formulas 1 and 2, X₁ and X₂ may be independently functional groups 124 used for coupling of the oligomer probes 165 or the linkers 140. Non-limiting examples of the functional groups 124 include hydroxyl groups, aldehyde groups, carboxyl groups, amino groups, amide groups, thiol groups, halo groups, and sulfonate groups.

Terminating functional groups of at least some of the immobilizing branches 123 exposed on the surfaces of the probe cell actives 120 are coupled with the oligomer probes 165 or the linkers 140. Some of the immobilizing branches 123 exposed on the surfaces of the probe cell actives 120 may not be coupled with the oligomer probes 165 or the linkers 140, and the functional groups 124 may remain in the terminals thereof, instead. The remaining functional groups 124 are rendered inactive by capping using capping groups 155.

The linkers 140 that mediate coupling with the oligomer probes 165 may further be provided on the probe cell actives 120. The linkers 140 may provide selective activation characteristics for in-situ synthesis of the oligomer probes 165 having different sequences by each of the probe cell actives 120. In addition, the linkers 140 may provide a spatial margin for hybridization when the immobilizing branches 123 exposed on the surfaces of the probe cell actives 120 are not long enough to effectuate such hybridization. To this end, the linkers 140 may have a sufficient molecular length, e.g., 6-50 atoms.

The linkers 140 may be made of a material including coupling groups capable of coupling with the functional groups 124 attached to the immobilizing branches 123 and the functional groups 150 capable of coupling with the oligomer probes 165. The linkers 140 are coupled with the immobilizing branches 123 exposed on the surfaces of the probe cell actives 120 using the coupling group and coupled with the oligomer probes 165 using the functional groups 150. The uncoupled functional groups 150 may be rendered inactive by capping using the capping groups 155.

Meanwhile, when the immobilizing branches 123 are sufficiently long enough to provide a spatial margin to ensure hybridization and have selective activation means or selective coupling means depending on the respective probe cell actives 120, the linkers 140 may be omitted.

The probe cell isolation region 130 is a region from which a siloxane resin layer is removed, and a surface of the substrate 110 is directly exposed in the probe cell isolation region 130. The probe cell actives 120 are separated from each other by the probe cell isolation region 130. Oligomer probes having the same sequence may be coupled to each one of the probe cell actives 120. Different probe cell actives 165 may couple with oligomer probes having different sequences.

As described above, as the surface of the substrate 110, without a siloxane resin layer, is directly exposed in the probe cell isolation region 130, there are few functional groups 124 and 150 capable of coupling with the oligomer probes 165. Accordingly, there is little probability of generating noises due to unwanted coupling with the oligomer probes 165 in the probe cell isolation region 130.

In the current embodiment, as the immobilizing branches 123 having C1-C30 hydrocarbons, preferably C5-C15 hydrocarbons, are exposed on the surfaces of the probe cell actives 120, the probe cell actives 120 can be directly coupled with the oligomer probes 165 without additional structures and can provide a spatial margin for a free interaction between the oligomer probes 165 and a target sample.

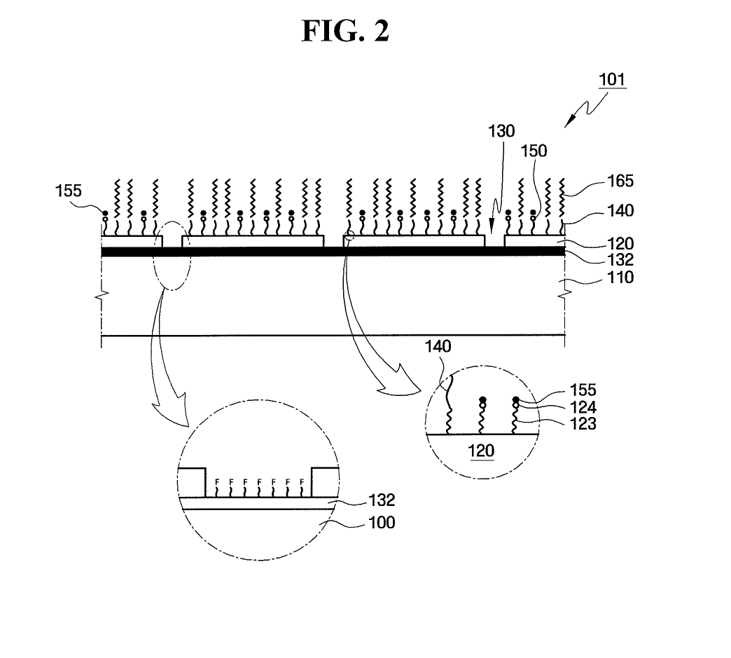

FIG. 2 is a sectional view illustrating a microarray (101) according to another embodiment of the present invention.

Referring to FIG. 2, the microarray 101 according to the illustrated embodiment of the present invention includes a coupling blocking film 132 formed on the entire surface of a substrate 110, and probe cell actives 120 are formed on the coupling blocking film 132, unlike the microarray 100 according to the previous embodiment illustrated in FIG. 1, in which the probe cell actives 120 are formed on the substrate 110. The coupling blocking film 132 is exposed in a probe cell isolation region 130. The coupling blocking film 132 may be made of, for example, fluorine-containing fluoride such as fluorosilane. The coupling blocking film 132 may also be, for example, a silicide film, a polysilicone film, or an epitaxial film of silicon (Si) or silicon germanium (SiGe). In the current embodiment of the present invention, functional groups 124 and 150 capable of coupling with oligomer probes 165 are absent in the probe cell isolation region 130 due to the presence of the coupling blocking film 132, thereby more efficiently preventing noise generation.

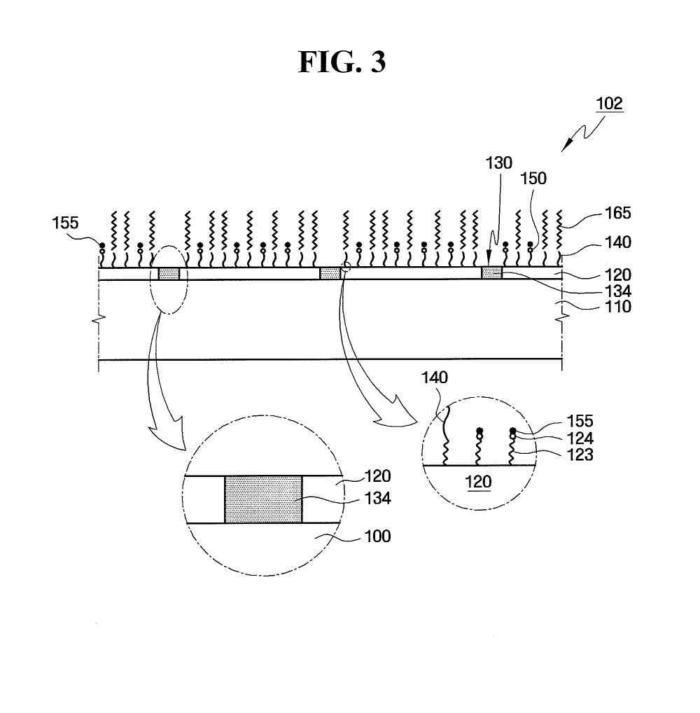

FIG. 3 is a sectional view illustrating a microarray (102) according to still another embodiment of the present invention.

Referring to FIG. 3, the microarray 102 according to the illustrated embodiment of the present invention includes a probe cell isolation region 130 filled with a coupling blocking filler 134 which has characteristics preventing the coupling of oligomer probes 165 or monomers for probe synthesis, unlike the microarray 100 of the previous embodiment illustrated in FIG. 1. The coupling blocking filler 134 may be made of, for example, fluorine-containing fluoride, polysilicone, or the like. According to the current embodiment of the present invention, the probe cell isolation region 130 is filled with the coupling blocking filler 134, and thus, functional groups 124 and 150 capable of coupling with the oligomer probes 165 are absent on the surface of the microarray 102, thereby more efficiently preventing noise generation.

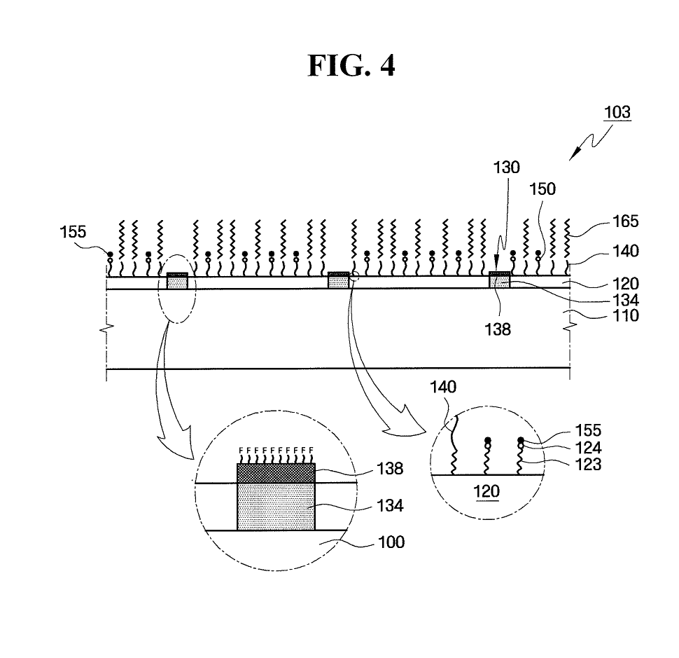

FIG. 4 is a sectional view illustrating a microarray (103) according to a further embodiment of the present invention.

Referring to FIG. 4, the microarray 103 according to the illustrated embodiment of the present invention includes a filler 134 filled in an area defined between probe cell actives 120 and a coupling blocking film 138 formed on the filler 134 present in a probe cell isolation region 130. In this case, it is not necessarily required that the filler 134 has characteristics preventing the coupling of oligomer probes 165. According to the current embodiment of the present invention, the probe cell isolation region 130 is covered with the filler 134 and the coupling blocking film 138, and thus, functional groups 124 and 150 capable of coupling with the oligomer probes 165 are absent in the probe cell isolation region 130, thereby more efficiently preventing noise generation.

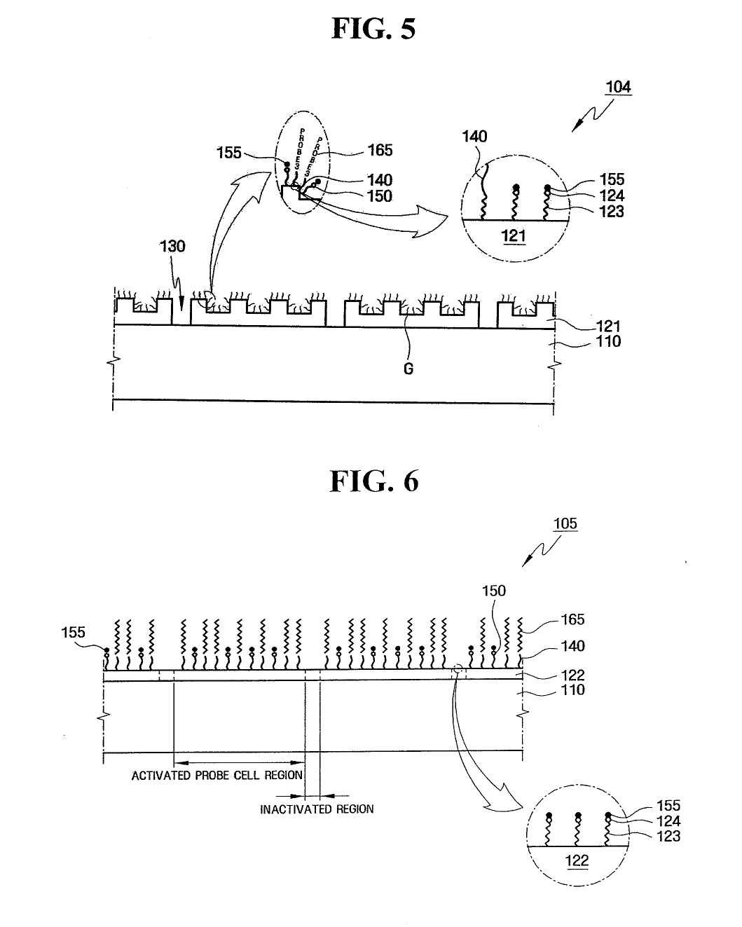

FIG. 5 is a sectional view illustrating a microarray (104) according to yet another embodiment of the present invention.

Referring to FIG. 5, the microarray 104 according to the illustrated embodiment of the present invention is different from the microarray 100 according to the previous embodiment illustrated in FIG. 1 in that probe cell actives 120 have three-dimensional surfaces. Here, the three-dimensional surfaces of the probe cell actives 120 are defined by one or more grooves G1 formed in the probe cell actives, but it should be understood that structures capable of defining a three-dimensional surface are not limited to the grooves G. The three-dimensional surfaces can increase an area capable of coupling with the oligomer probes 160. Accordingly, the number of the oligomer probes 160 coupled to the probe cell actives 120 can be increased compared to the case of the microarray having the same design rule. As a result, even when a reduced design rule is employed, desired detection sensitivity can be ensured.

In addition, as a modification of the above-described embodiments, probe cell actives 120 of the microarrays 101 through 103 shown in FIGS. 2 through 4 may have three-dimensional surfaces shown in FIG. 5.

FIG. 6 is a sectional view illustrating a microarray (105) according to still another embodiment of the present invention.

Referring to FIG. 6, the microarray 105 according to the illustrated embodiment, of the present invention is different from the microarray 100 according to the previous embodiment illustrated in FIG. 1 in that a siloxane resin layer 122 does not have physically separated regions.

In more detail, the siloxane resin layer 122 formed on a substrate 110 is represented by the general formula 1 or 2 and made of a siloxane resin having a molecular weight of about 1,000 to about 10,000.

The siloxane resin layer 122 includes a plurality of activated probe cell regions with a plurality of oligomer probes 165 coupled therewith and inactivated regions without oligomer probes 165 coupled therewith. The inactivated regions surround the activated probe cell regions. From the functional viewpoint, the activated probe cell regions are substantially the same as the probe cell actives (120 of FIG. 1) and the inactivated regions are substantially the same as the probe cell isolation region (130 of FIG. 1). However, as the inactivated regions have the siloxane resin layer 122, immobilizing branches 123 are formed on a surface of the siloxane resin layer 122, unlike in FIG. 1.

In the inactivated regions, functional groups 124 remain in terminals of the immobilizing branches 123 exposed on the surface of the siloxane resin layer 122. The remaining functional groups 124 may be rendered inactive by capping using capping groups 155. In addition, the terminating functional groups of the immobilizing branches 123 may be coupled with linkers in the inactivated regions, in which the linkers are rendered inactive. Thus, oligomer probes are not coupled with the immobilizing branches 123 disposed in the inactivated regions.

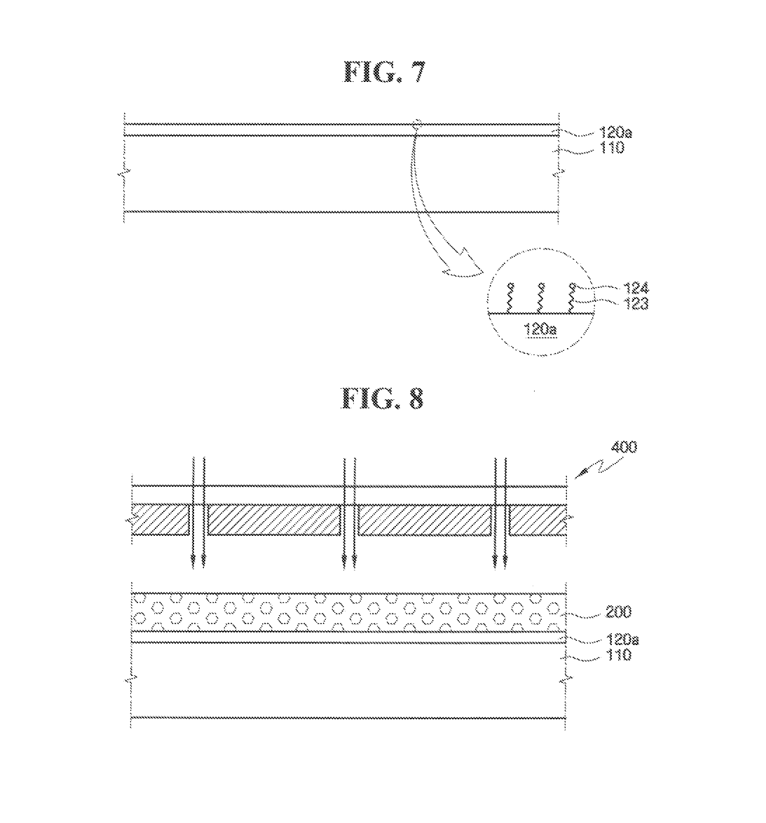

Hereinafter, methods of manufacturing microarrays according to some embodiments of the present invention will be described with reference to FIGS. 7 through 12.

FIGS. 7 through 12 are sectional views of intermediate structures for illustrating a method of manufacturing the microarray shown in FIG. 1.

Referring to FIG. 7, a siloxane resin layer 120a represented by the general formula 1 or 2 and having a molecular weight of about 1,000 to about 10,000 is formed on the substrate 110:

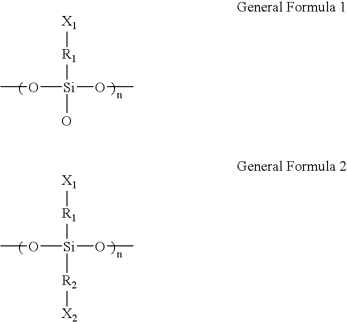

where R₁ and R₂ are independently hydrocarbons having 1 to 30 carbon atoms, and X₁ and X₂ may be independently functional groups 124 used for coupling of the oligomer probes 165 or the linkers 140. Non-limiting examples of the functional groups 124 include hydroxyl groups, aldehyde groups, carboxyl groups, amino groups, amide groups, thiol groups, halo groups, and sulfonate groups.

The siloxane resin layer 120a can be formed by, for example, slit coating or spin coating. Here, as the slit coating or spin coating is simpler than oxidation or CVD and the process duration thereof is short, the processing efficiency can be improved.

Next, the siloxane resin layer 120a is baked. The baking temperature is in a range of, for example, about 100° C. to about 400° C., preferably in a range of about 200° C. to about 300° C. The baking time is in a range of about 30 seconds to about 1 hour.

After baking the siloxane resin layer 120a, siloxane resin molecules in the siloxane resin layer 120a are crosslinked to each other, thereby densifying the siloxane resin layer 120a, The immobilizing branches 123 are exposed on a surface of the siloxane resin layer 120a having tire functional groups 124 attached thereto.

Referring to FIG. 8, after forming a photoresist layer 200 on the siloxane resin layer 120a, the photoresist layer 200 is exposed to light using a photo mask 400 defining a plurality of probe cell actives 120.

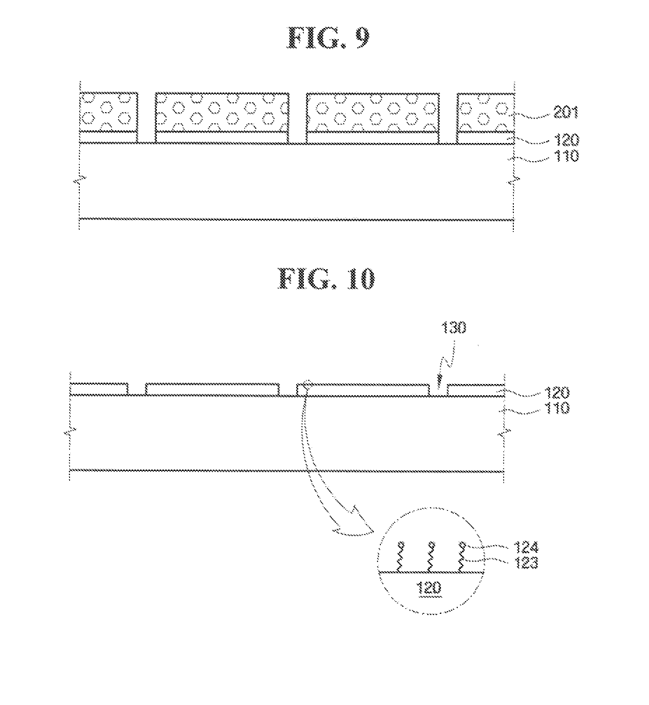

Referring to FIG. 9, the exposed photoresist layer 200 is developed to form a photoresist pattern 201 to be used as an etching mask. Then, the siloxane resin layer 120a is etched using the photoresist pattern 201 as the etching mask, thereby forming the plurality of probe cell, actives 120. Here, a region removed by etching the siloxane resin layer 120a exposes a surface of a substrate 110 to become a probe cell isolation region 130.

Referring to FIG. 10, the photoresist pattern 201 is removed to complete the probe cell actives 120,

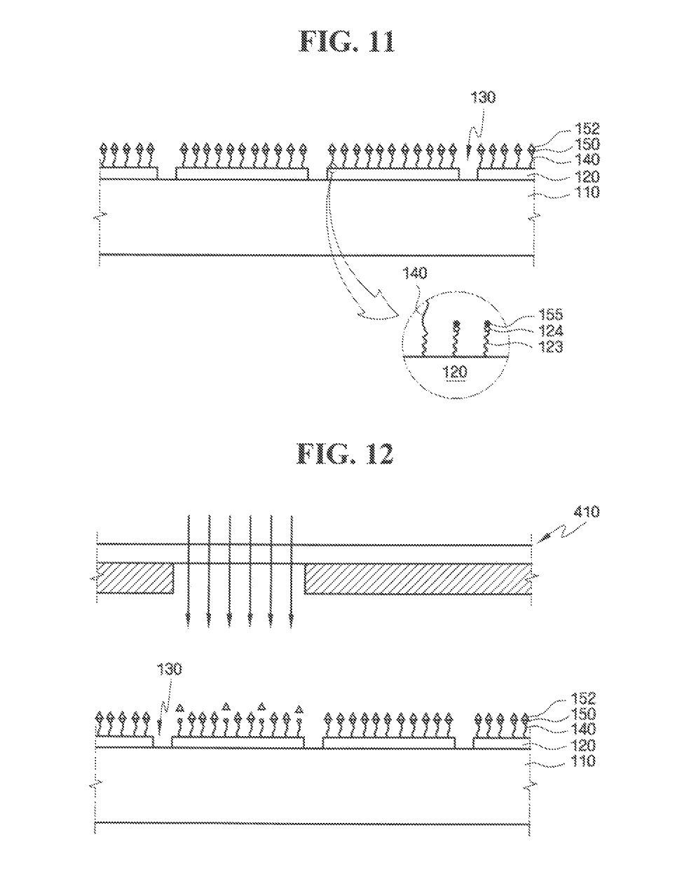

Referring to FIG. 11, linkers 140 having photolabile protecting groups 152 attached thereto are coupled with the functional groups 124 attached to the immobilizing branches 123 exposed on the surface of the probe cell actives 120. The linkers 140 may be, for example, phosphoramidites having, the photolabile protecting groups 152. The photolabile protecting groups 152 may be selected from the group consisting of, for example, a variety of positive photolabile protecting groups including aromatic nitro compounds such as o-nitrobenzyl derivatives or benzyl sulfonyl groups. Preferred examples of the photolabile protecting groups 152 include 6-nitroveratriloxycarbonyl (NVOC), 2-nitrobenyloxylcarbonyl (NBOC), α,α-dimethyl-dimethoxybenyloxylcarbonyl (DDZ), and dimethoxytrityl (DMT) groups.

The surface-exposed functional groups 124 that remain unreacted with the linkers 140 after coupling, are rendered inactive by capping using capping groups 155 to prevent the unreacted functional groups 124 from generating noise in oligomer probes.

Referring to FIG. 12, the photolabile protecting groups 152 attached to the terminating functional groups 150 of the linkers 140 are deprotected using a mask 410 exposing desired oligomer probe cell actives 120 for in-situ synthesis of oligomer probes.

In addition, desired oligomer probes 165 can be coupled to the exposed functional groups 150. For example, in the case of synthesizing oligomer probes by in-situ photolithography, nucleotide phosphoramidite monomers having acid-labile protecting groups attached thereto are coupled to the exposed functional groups 150, uncoupled functional groups 150 are rendered inactive by capping using capping groups 155, and oxidation of phosphite triester structures between phosphoramidites and 5′-hydroxyl groups to phosphate structures is performed. As described above, the deprotection of the desired probe cell actives 120, the coupling of monomers having desired sequences, the capping of uncoupled functional groups using capping groups 155, and the oxidation of photophite trimester structures into phosphate trimester structures, are sequentially and repeatedly performed, thereby synthesizing the oligomer probes 165 having different sequences by each of the probe cell actives 120 while oligomer probes 165 having the same sequence are coupled to each one of the probe cell actives 120.

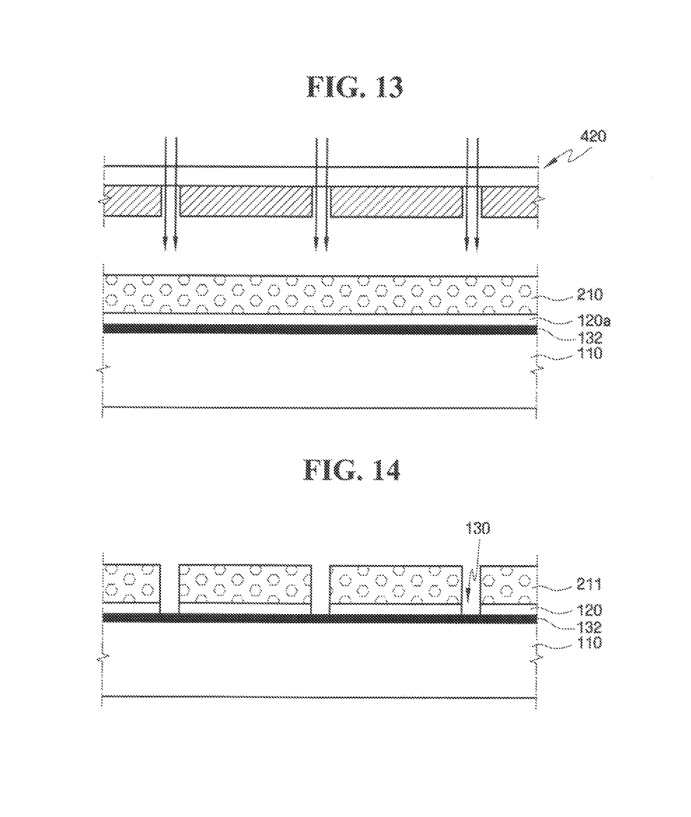

FIGS. 13 and 14 are sectional views of intermediate structures for illustrating a method of manufacturing the microarray shown in FIG. 2.

Referring to FIG. 13, the coupling blocking film 132, the siloxane resin layer 120a, and a photoresist film 210 are sequentially formed on the substrate 110. Then, the photoresist film 210 is exposed to light using a photomask 420 defining the probe cell actives 120.

Referring to FIG. 14, the exposed photoresist film 210 is developed to form a photoresist pattern 211, and the siloxane resin layer 120a is etched using the photoresist pattern 211 as an etching mask to form the probe cell actives 120. The coupling blocking film 132 is exposed between the probe cell actives 120 to define the probe cell isolation region 130. The subsequent processes are performed in substantially the same manner as described above with reference to FIGS. 10 through 12.

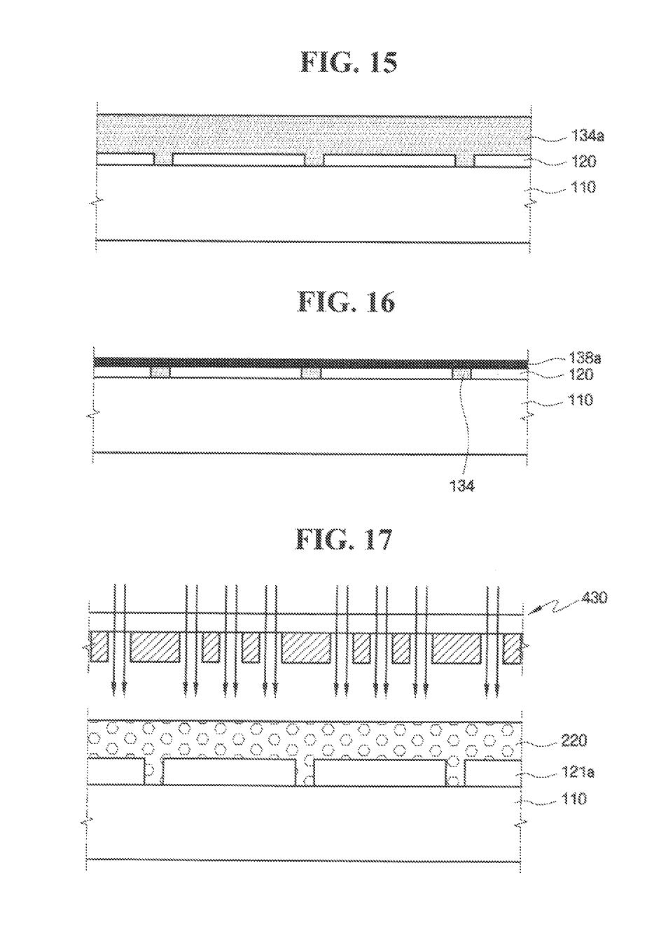

FIG. 15 is a sectional view of the intermediate structure for illustrating a method of manufacturing the microarray shown in FIG. 3.

Referring to FIG. 15 probe cell actives 120 formed as a siloxane resin layer are formed in the same manner as described above with reference to FIGS. 7 through 10, and a filler film 134a filling an area defined between the probe cell actives 120 is formed. The filler film 134a may be made of a material having characteristics preventing the coupling of oligomer probes and good gap-filling characteristics, e.g., fluorosilane or polysilicone.

Next, the filler film 134a is planarized by, for example, a Chemical Mechanical Polishing (CMP) or etch-back process to expose surfaces of the probe cell actives 120, thereby completing the coupling blocking filler 134 which is filled in the area defined between the probe cell actives 120.

FIG. 16 is a sectional view of the intermediate structure for illustrating a method of manufacturing the microarray shown in FIG. 4.

Referring to FIG. 16, the probe cell actives 120 and the filler 134 filled in an area defined between the probe cell actives 120 are formed on the substrate 110 in the same manner as described above with reference to FIGS. 7 through 10. Then, a coupling blocking film 138a is formed on the entire surface of the substrate 110.

Next, the coupling blocking film pattern 138a formed on the probe cell actives 120 is selectively removed to complete the filler 134 and the coupling blocking film 138 formed on the filler 134. Alternatively, in a case where the filler 134 is formed as a polysilicone film or an epitaxial film of Si or SiGe and the coupling blocking film pattern 138a is formed as a metal film using cobalt (Co), nickel (Ni), or titanium (Ti), the coupling blocking film 138 can remain only on the filler 134 by silicidation and then removal of unreacted metal film portions.

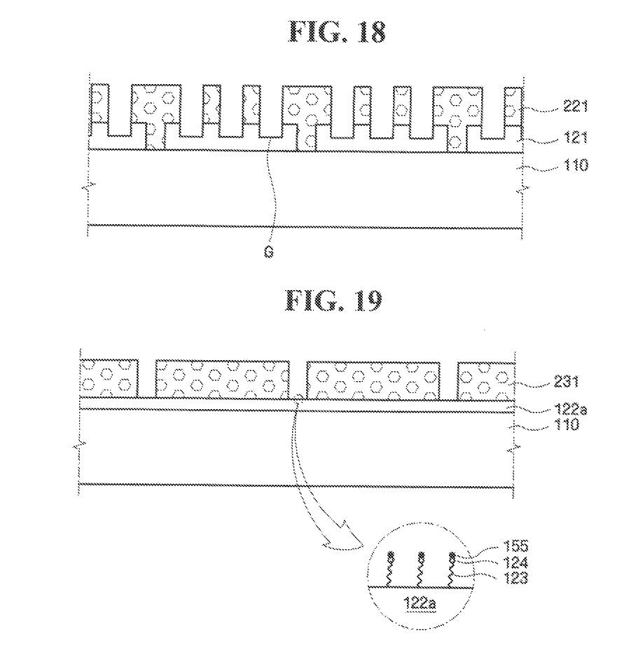

FIGS. 17 and 18 are sectional views of intermediate structures for illustrating a method of manufacturing the microarray shown in FIG. 5.

Referring to FIG. 17, a siloxane resin layer 121a is formed in the same manner as described in FIGS. 7 through 10, a photoresist film 220 is coated thereon, and the photoresist film 220 is exposed to light using a photomask 430 defining a patterned layer having grooves (G).

Referring to FIG. 18, the exposed photoresist film 220 is developed to form a photoresist pattern 221 defining the patterned layer having grooves (G), and the siloxane resin layer 121a is etched using the photoresist pattern 221 as an etching mask to form the probe cell actives 120.

FIG. 19 is a sectional view of the intermediate structure for illustrating a method of manufacturing the microarray shown in FIG. 6.

Referring to FIG. 19, a siloxane resin layer 122a is formed on the substrate 110 in the same manner as described in FIG. 7. Next, a photoresist film is formed on the siloxane resin layer 122a, followed by exposing to light and etching, thereby forming a photoresist pattern 231 exposing inactivated regions. Then, the entire surface of the resultant product is capped using the capping groups 155. As the result of the capping, the functional groups 124 of the immobilizing branches 123 exposed on the siloxane resin layer 122a in the inactivated regions are all capped. Next, the photoresist pattern 231 is removed and the subsequent processes are performed in substantially the same manner as described above with reference to FIGS. 11 and 12, thereby completing the microarray illustrated in FIG. 6.

Hereinafter, embodiments of the present invention will be described more specifically with reference to the following experimental examples.

### EXPERIMENTAL EXAMPLE 1

### Synthesis of Probe Cell Actives

Siloxane resin layers containing (CH₂)₁₀—OH group were formed to a thickness of about 90 nanometers (am) on silicone wafers using a spin coating process and baked at about 250° C. for about 60 seconds. Photoresist films were formed to a thickness of about 3.0 micrometers (μm) on the resultant structures using a spin-coating process and baked at about 100° C. for about 60 seconds. Then, the photoresist films were exposed to light in a 365 nm-wavelength projection exposure machine using about 1.0 μm pitch checkerboard type dark tone masks and then developed with about a 2.38% TetraMethylAmmonium Hydroxide (TMAH) solution to form checkerboard type photoresist patterns so that the underlying siloxane resin layers were exposed in the form of a plurality of intersecting stripes. The siloxane resin layers were etched using the photoresist patterns as etching masks to be patterned into the probe cell actives. Subsequently, the patterned probe cell actives were treated with an acetonitrile solution containing amidite-activated NNPOC-tetraethyleneglycol and tetrazole (1:1) so that phosphoramidite protected with photolabile groups was coupled to the patterned probe cell actives and then acetyl-capped to thereby complete protected linker structures.

### EXPERIMENTAL EXAMPLE 2

### Synthesis of Probe Cell Actives

Synthesis of probe cell actives was performed in substantially the same manner as in Experimental Example 1 except that siloxane resin layers containing (CH₂)₁₀—NH₂ group, instead of (CH₂)₁₀—OH group, were used.

### EXPERIMENTAL EXAMPLE 3

### Synthesis of Probe Cell Actives

Synthesis of probe cell actives was performed in substantially the same manner as in Experimental Example 1 except that siloxane resin layers containing hydroxylcyclohexyl group, instead of (CH₂)₁₀—OH group, were used.

<In-situ Synthesis of Oligonucleotide Probes>

In-situ photolithographic synthesis of oligonucleotide probes was performed on substrates having the probe cell actives synthesized in Experimental Examples 1 through 3 and cell isolation regions.

For this, the siloxane resin layer were exposed to light using a binary mask exposing predetermined siloxane resin layer in a 365 nm-wavelength projection exposure machine with an energy of about 1000 millijoules mJ/cm² for about one minute to deprotect terminating functional groups of the linker structures. Then, the siloxane resin layer were treated with an acetonitrile solution containing amidite-activated nucleotide and tetrazole (1:1) to achieve coupling of the protected nucleotide monomers to the deprotected linker structures, and then treated with a THF solution, (acetic anhydride (Ac20)/pyridine (py)/methylimidazole=1:1:1) and a about 0.02 M iodine-THF solution to perform capping and oxidation.

The above-described deprotection, coupling, capping, and oxidation processes were repeated to form oligonucleotide probes having different sequences by each of a plurality of probe cell active regions.

In microarrays according to embodiments of the present invention, as immobilizing branches are exposed on a surface of a siloxane resin layer forming probe cell actives, the probe cell actives can be directly coupled with oligomer probes or linkers providing selective activation characteristics without additional structures. In addition, in a case where immobilizing branches exposed on a surface of a siloxane resin layer have sufficient carbon atoms, a spatial margin for a free interaction between the oligomer probes and a target sample can be provided.

In methods of fabricating the microarrays according to embodiments of the present invention, as a siloxane resin layer is formed by spin coating or slit coating, which shortens the process duration, the processing efficiency can thereby be improved.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A microarray comprising:
a substrate;
a siloxane resin layer represented by the following general formula 1 or 2 and which includes a siloxane resin having a molecular weight of about 1,000 to about 10,000: 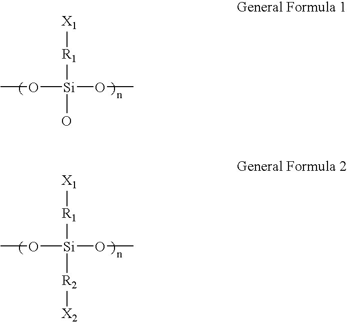
wherein R₁ and R₂ are independently hydrocarbons having 1 to 30 carbon atoms and X₁ and X₂ are independently a hydroxyl, aldehyde, carboxyl, amino, amide, thiol, halo, or sulfonate group; and
a plurality of oligomer probes coupled with the siloxane resin layer.

2. The microarray of claim 1, wherein terminating functional groups of at least some of the hydrocarbons of the general formula 1 or 2 are immobilizing branches exposed on the surface of the siloxane resin layer, and the oligomer probes are coupled with the immobilizing branches.

3. The microarray of claim 2, further comprising linkers via which the oligomer probes are coupled with the immobilizing branches exposed on the surface of the siloxane resin layer.

4. The microarray of claim 2, further comprising a probe cell isolation region which separates the siloxane resin layer into a plurality of probe cell actives and does not have on its surface functional groups coupled with the oligomer probes.

5. The microarray of claim 4, wherein the surface of the probe cell isolation region comprises one of an exposed silicone substrate or a transparent glass substrate.

6. The microarray of claim 4, wherein the surface of the probe cell isolation region is a surface of an oligomer probe coupling blocking film formed on the upper surface of the substrate.

7. The microarray of claim 4, wherein the surface of the probe cell isolation region is a surface of a filler filled in an area defined between the probe cell actives and having characteristics preventing the coupling of the oligomer probe.

8. The microarray of claim 4, wherein the surface of the probe cell isolation region is a surface of an oligomer probe coupling blocking film formed on a filler filled in an area defined between the probe cell actives.

9. The microarray of claim 2, wherein the siloxane resin layer comprises a plurality of activated probe cell regions with a plurality of oligomer probes coupled therewith and inactivated regions without oligomer probes coupled therewith, the inactivated regions surrounding the activated probe cell regions, and the immobilizing branches in the inactivated regions are rendered inactive by capping.

10. The microarray of claim 1, wherein the hydrocarbons are straight chain or branched alkyl, alkenyl or alkynyl group, cycloalkyl or cycloalkenyl groups having 1 to 30 carbon atoms.

11. A method of fabricating a microarray, the method comprising:
providing a substrate;
forming a siloxane resin layer represented by the following general formula 1 or 2 and which includes a siloxane resin having a molecular weight of about 1,000 to about 10,000: 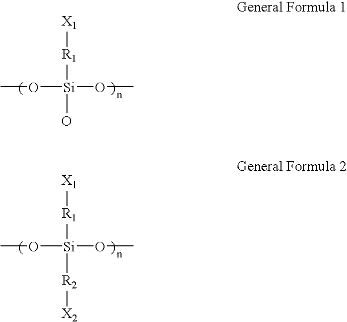
wherein R₁ and R₂ are independently hydrocarbons having 1 to 30 carbon atoms and X₁ and X₂ are independently a hydroxyl, aldehyde, carboxyl, amino, amide, thiol, halo, or sulfonate group; and
coupling oligomer probes with the siloxane resin layer.

12. The method of claim 11, wherein the forming of the siloxane resin layer comprises exposing at least some of the hydrocarbons of the general formula 1 or 2 to the surface of the siloxane resin layer, and the coupling of the oligomer probes comprises coupling the oligomer probes with the immobilizing branches.

13. The method of claim 12, wherein the forming of the siloxane resin layer comprises coating the siloxane resin layer on the substrate and baking the coated siloxane resin layer at a temperature in a range of about 100° C. to about 400° C.

14. The method of claim 12, wherein the coupling of the oligomer probes comprises coupling the oligomer probes with the immobilizing branches exposed on the surface of the siloxane resin layer via linkers.

15. The method of claim 12, further comprising forming a probe cell isolation region winch separates the siloxane resin layer into a plurality of probe cell actives and does not have on its surface functional groups coupled with the oligomer probes, after the forming of the siloxane resin layer.

16. The method of claim 15, wherein the surface of the probe cell isolation region comprises one of an exposed silicone substrate or a transparent glass substrate.

17. The method of claim 15, wherein the surface of the probe cell isolation region is a surface of an oligomer probe coupling blocking film formed on the upper surface of the substrate.

18. The method of claim 15, wherein the surface of the probe cell isolation region is a surface of an oligomer probe coupling blocking film formed on a filler filled in an area defined between the probe cell actives.

19. The method of claim 15, wherein the surface of the probe cell isolation region is a surface of a filler filled in an area defined between the probe cell actives and having characteristics preventing the coupling of the oligomer probe.

20. The method of claim 12, further comprising inactivated regions in which the immobilizing branches are rendered inactive by capping and a plurality of activated probe cell regions surrounded by the inactivated regions, after the forming of the siloxane resin layer.

21. The method of claim 11, wherein the hydrocarbons are straight chain or branched alkyl, alkenyl or alkynyl group, cycloalkyl or cycloalkenyl groups having 1 to 30 carbon atoms.
